(19) United States
(12) Patent Application Publication
(10) Pub. No.: US 2025/0356690 A1
(43) Pub. Date: Nov. 20, 2025

(54) Systems And Methods for Multi-Frame Biometric Imaging

(71) Applicant: Metalenz, Inc., Boston, MA (US)

(72) Inventors: Robert C. Devlin, Concord, MA (US); Pawel Latawiec, Cambridge, MA (US); Gaurav Aggarwal, Boston, MA (US)

(73) Assignee: Metalenz, Inc., Boston, MA (US)

(21) Appl. No.: 19/210,923

(22) Filed: May 16, 2025

Related U.S. Application Data
(60) Provisional application No. 63/648,989, filed on May 17, 2024.

(51) Int. Cl. G06V 40/16; G06V 10/30; G06V 10/82; H04N 25/62

(52) U.S. Cl. CPC G06V 40/167; G06V 10/30; G06V 10/82; G06V 40/166; H04N 25/62

(57) ABSTRACT

Systems and methods for performing multi-frame imaging are illustrated. One embodiment includes a method of performing biometric identification. The method captures an “off” and “on” set of frames. The “off” set of frames depicts an object when illuminated by externally-sourced illumination. The “on” set of frames depicts the object when illuminated by the externally-sourced illumination and an illuminator. The “off” and “on” set of frames are each polarized in a set of near-infrared wavelengths. The method performs an image enhancing technique to produce a denoised image. The image enhancing technique includes a multi-frame noise reduction technique based on a plurality of spatial aspects of image signals in both of: the “off” set of frames; and the “on” set of frames. The image enhancing technique removes the externally-sourced illumination from the “on” set of frames in producing the denoised image. The method performs an authentication based on the denoised image.

### CROSS-REFERENCE TO RELATED APPLICATIONS

This application claims priority to U.S. Provisional Patent Application No. 63/648,989, filed May 17, 2024, the disclosure of which is incorporated herein by reference.

### FIELD OF THE INVENTION

The current disclosure is directed to image enhancement techniques, specifically image enhancement techniques based on bursts of illuminated and unilluminated images.

### BACKGROUND

Metasurfaces include a plurality of metasurface elements, diffractive optical elements in which individual waveguide elements have subwavelength spacing and have a planar profile. Metasurface elements have recently been developed for application in the UV-IR bands (300-10,000 nm). Compared to traditional refractive optics, metasurface elements may introduce phase shifts onto the light field and/or alter the polarization state of the light. Metasurface elements have thicknesses or cross-sectional dimensions on the order of the wavelength of light at which they are designed to operate, whereas traditional refractive surfaces have thicknesses that are 10-100 times (or more) larger than the wavelength of light at which they are designed to operate. Additionally, metasurface elements may have no variation in thickness along or parallel to the optical axis in the constituent elements and thus are able to shape light without any curvature, as typically included in refractive optics. Compared to traditional diffractive optical elements (DOEs), for example binary diffractive optics, metasurface elements have the ability to impart a range of phase shifts on an incident light field, at a minimum the metasurface elements can have phase shifts between 0-2TT with at least 5 distinct values from that range, whereas binary DOEs are only able to impart two distinct functional values of phase shift and are often limited to phase shifts of either 0 or 1π. Compared to multi-level DOE's, metasurface elements do not require height variation of its constituent elements along the optical axis, only the in-plane geometries of the metasurface element features vary.

### SUMMARY OF THE INVENTION

Systems and methods for performing multi-frame imaging are illustrated. One embodiment includes a method of performing biometric identification. The method captures an “off” set of frames and an “on” set of frames. The “off” set of frames depicts an object when illuminated by externally-sourced illumination. The “on” set of frames depicts the object when illuminated by the externally-sourced illumination and an illuminator. The “off” set of frames and the “on” set of frames are each polarized in a set of near-infrared wavelengths. The method performs at least one image enhancing technique to produce a denoised image. The at least one image enhancing technique includes a multi-frame noise reduction technique based on a plurality of spatial aspects of image signals in both of: the “off” set of frames; and the “on” set of frames. The at least one image enhancing technique removes the externally-sourced illumination from the “on” set of frames in producing the denoised image. The method performs an authentication based on the denoised image.

In another embodiment, performing the at least one image enhancing technique includes inputting the “off” set of frames and the “on” set of frames into a trained machine learning algorithm.

In another embodiment, the at least one image enhancing technique includes performing a polarimetric measurement of at least one of the “off” set of frames or the “on” set of frames.

In yet another embodiment, the object is a human face; and the authentication includes at least one selected from the group consisting of an anti-spoof detection, a face recognition, an iris recognition, a palm recognition, a fingerprint recognition, a retinal scan, an eye tracking, a facial matching, and an access determination.

In another embodiment, the at least one image enhancing technique further includes a multi-frame super resolution technique based on the plurality of spatial aspects of the image signals.

In yet another embodiment, each individual frame obtained for the “on” set of frames alternates with a counterpart frame obtained for the “off” set of frames. Performing the multi-frame noise reduction technique includes, for the each individual frame, subtracting the counterpart frame from the each individual frame to create an individual modified frame.

In a further embodiment, subtracting the counterpart frame from the each individual frame includes subtracting pixels at a consistent location in both frames.

In another further embodiment, performing the multi-frame noise reduction technique further includes averaging a set of individual modified frames to reduce noise in the denoised image.

In a still further embodiment, averaging the set of individual modified frames includes averaging pixels across a consistent location in each individual modified frame.

In another embodiment, the “off” set of frames and the “on” set of frames are both captured in YUV format. The at least one image enhancing technique operates on luma (Y) and chroma (U, V) channels.

One embodiment includes a non-transitory machine-readable medium including instructions that, when executed, are configured to cause a processor to perform a biometric identification process. The biometric identification process captures an “off” set of frames and an “on” set of frames. The “off” set of frames depicts an object when illuminated by externally-sourced illumination. The “on” set of frames depicts the object when illuminated by the externally-sourced illumination and an illuminator. The “off” set of frames and the “on” set of frames are each polarized in a set of near-infrared wavelengths. The biometric identification process performs at least one image enhancing technique to produce a denoised image. The at least one image enhancing technique includes a multi-frame noise reduction technique based on a plurality of spatial aspects of image signals in both of: the “off” set of frames; and the “on” set of frames. The at least one image enhancing technique removes the externally-sourced illumination from the “on” set of frames in producing the denoised image. The biometric identification process performs an authentication based on the denoised image.

In another embodiment, performing the at least one image enhancing technique includes inputting the “off” set of frames and the “on” set of frames into a trained machine learning algorithm.

In another embodiment, the at least one image enhancing technique includes performing a polarimetric measurement of at least one of the “off” set of frames or the “on” set of frames.

In yet another embodiment, the object is a human face; and the authentication includes at least one selected from the group consisting of an anti-spoof detection, a face recognition, an iris recognition, a palm recognition, a fingerprint recognition, a retinal scan, an eye tracking, a facial matching, and an access determination.

In another embodiment, the at least one image enhancing technique further includes a multi-frame super resolution technique based on the plurality of spatial aspects of the image signals.

In yet another embodiment, each individual frame obtained for the “on” set of frames alternates with a counterpart frame obtained for the “off” set of frames. Performing the multi-frame noise reduction technique includes, for the each individual frame, subtracting the counterpart frame from the each individual frame to create an individual modified frame.

In a further embodiment, subtracting the counterpart frame from the each individual frame includes subtracting pixels at a consistent location in both frames.

In another further embodiment, performing the multi-frame noise reduction technique further includes averaging a set of individual modified frames to reduce noise in the denoised image. Averaging the set of individual modified frames includes averaging pixels across a consistent location in each individual modified frame.

In another embodiment, the “off” set of frames and the “on” set of frames are both captured in YUV format. The at least one image enhancing technique operates on luma (Y) and chroma (U, V) channels.

One embodiment includes an imaging device for performing a biometric identification, the imaging device. The imaging device includes a camera including: an illuminator; and at least one polarization image sensor. The imaging device includes a memory, storing instructions. The imaging device includes a processor configured to communicate data with the camera and the memory, the processor further configured to execute the instructions. The processor captures, using the at least one polarization image sensor, an “off” set of frames and an “on” set of frames. The “off” set of frames depicts an object when illuminated by externally-sourced illumination. The “on” set of frames depicts the object when illuminated by the externally-sourced illumination and the illuminator. The “off” set of frames and the “on” set of frames are each polarized in a set of near-infrared wavelengths. The processor performs at least one image enhancing technique to produce a denoised image. The at least one image enhancing technique includes a multi-frame noise reduction technique based on a plurality of spatial aspects of image signals in both of: the “off” set of frames; and the “on” set of frames. The at least one image enhancing technique removes the externally-sourced illumination from the “on” set of frames in producing the denoised image. The processor performs an authentication based on the denoised image.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which form a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates a process representing an imaging pipeline implemented in accordance with many embodiments of the invention.

FIG. 2 illustrates an example of a multi-image noise reduction process implemented in accordance with numerous embodiments of the invention.

FIGS. 3A-3B illustrate a schematic timing diagram of an example multi-frame enhancement process, performed in accordance with several embodiments of the invention.

FIG. 4 illustrates an example of an imaging system that performs image processing and computer vision in accordance with various embodiments of the invention.

FIG. 5 illustrates a block diagram of a computing configuration which may be used for authentication and/or identification purposes (e.g., facial recognition) in accordance with many embodiments of the invention.

FIG. 6 illustrates a combined imaging module in accordance with some embodiments of the invention.

FIG. 7A-7C illustrate views of an image sensor configured in accordance with miscellaneous embodiments of the invention.

### DETAILED DESCRIPTION

Various embodiments of the invention relate to capturing and using altered images, including but not limited to near-infrared (NIR) and polarized images to refine visible images. In doing so, systems implemented in accordance with various embodiments may determine improved noise reduction, obtain better resolution, and/or manage lighting. Systems may, in various cases, be configured to capture images of polarized light in NIR wavelengths. These images may be used for enabling downstream applications, including but not limited to biometric authentication. In accordance with many embodiments of the invention, techniques including but not limited to multi-frame image captures and computational imaging (processing) may be used to enhance one or more aspects of input images. Specifically, the multi-frame capture may enhance resolution on various channels including but not limited to polarization channels.

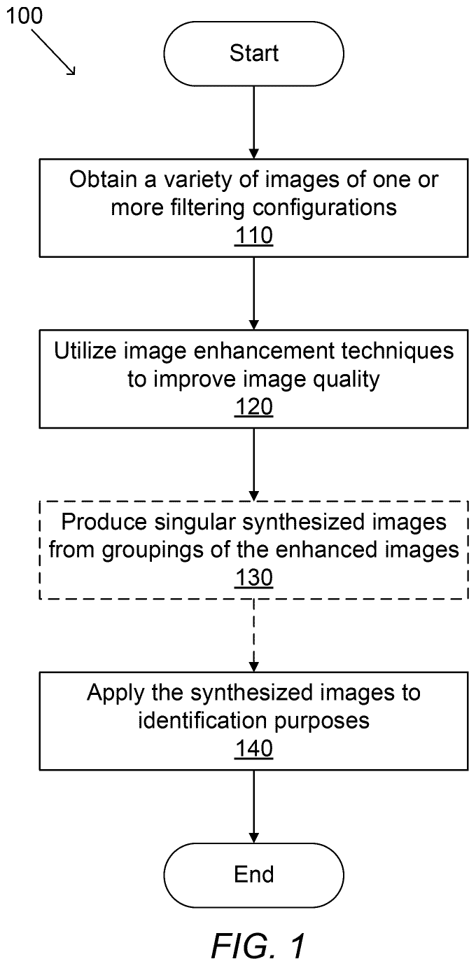

A process representing an imaging pipeline implemented in accordance with many embodiments of the invention is illustrated in FIG. 1. Process 100 may be performed by, but is not limited to, machine learning models such as (e.g., feedforward, convolutional, recurrent) neural networks. Process 100 obtains (110) a variety of images of one or more image configurations. In accordance with several embodiments of the invention, images may be captured in various forms. For example, certain images may be interpreted from image sensors (e.g., “debayered”) in various pixel formats (e.g., 8-bit images). Additionally or alternatively, images obtained in accordance with specific embodiments of the invention may be configured in imaging formats including but not limited to YUV.

In some embodiments, an illuminator may be turned on and off in order to capture different images. “On” (or light) frames are one possible configuration, referring to images that are captured with fixed illumination polarizations (e.g., multiple fixed polarized illuminations being used simultaneously). “Off” (or dark) frames are a second possible configuration, referring to images that are captured with unpolarized ambient light. Having polarized and/or unpolarized illumination may allow for a more complete polarization image to be built of the object being illuminated. The “on” and “off” illumination capture sequences may be utilized to gather background frames and differentiate images. In some circumstances, particularly those in challenging environments which present changes (in contrast) over the subject(s) being imaged, high-dynamic range imaging techniques (HDR) may be applied to imaging pipelines. In such cases, the exposure time of the light frame(s) and/or dark frame(s) can be varied across the bursts of frames in order to vary the exposure.

Process 100 utilizes (120) image enhancement techniques to improve image quality (where needed). In this disclosure, image enhancement (e.g., “burst enhancement”) techniques may refer to processes and/or algorithms used to improve image quality. Image enhancement techniques implemented in accordance with some embodiments may include but are not limited to multi-frame super-resolution (MFSR) and/or multi-frame noise reduction (MFNR) techniques. In order to preserve dynamic range and promote low-noise imaging, image enhancement techniques can be designed to work in various modes, suited to the needs and requirements of the imaging pipeline. In several embodiments, process 100 may perform pixel averaging to average out random noise (e.g., from motion, from stray light, from ambient light, from sensor effects).

With respect to the YUV imaging format of certain obtained images, image enhancement algorithms may operate on the respective luma (Y) and chroma (U, V) channels. In some embodiments of the invention, the luma channel may aid in denoising the UV channels, (and vice versa). In various embodiments of the invention, the output images may be enhanced (e.g., YUV) images. Additionally or alternatively, in several embodiments of the invention, obtained images may be up-sampled. In some embodiments of the invention, through demosaicing processes, YUV-formatted images may be used to describe the polarization state of the incident light. The demosaicing process may involve sensor configurations to individually arrive at similar pixel formats, regardless of the varied initial pixel formats.

In various embodiments, in utilizing (120) these image enhancement techniques, process 100 may produce (130) singular synthesized images from groupings of the enhanced images. As mentioned above, multi-frame (MF) image enhancement may be utilized to enhance images for improved (e.g., biometric) processing. In performing this enhancement, some multi-frame techniques may be used to take two or more image frames, and then add, subtract, and/or average those frames together to reduce noise effects and/or assist in smoothing out and/or enhancing images. Nevertheless, in some cases, multi-frame enhancement may be performed on (but is not limited to) small sets of (e.g., 2-20) images. In many cases, burst enhancement techniques may designate one or more obtained images to be “key” or reference images. In doing so, subsequent images can be compared to the reference image(s) for evaluation purposes. In accordance with a few embodiments of the invention, these synthesized images may be produced (130) in an accumulating manner, with the final output image being produced via averaging (i.e., to prevent overflow). Due to the potential drawback of limiting bit resolution during accumulation, additional compensatory steps may be incorporated to increase resolution. Further, during image synthesis, process 100 may reconstruct images from the multiple exposures. In some cases, this may involve widening the output type (e.g., from 8-bit to 10-bit or higher). Process 100 may, additionally or alternatively, ignore overexposed regions during synthesis, in order to present interpretable outputs.

As suggested above, applying image enhancement (including but not limited to MFSR) techniques on “on” and/or “off” frames may enhance the overall resolution of the resulting image(s). By adapting the format of the polarization output of the images, systems in accordance with various embodiments may convert known techniques (e.g., that were originally designed for RGB imaging) for MFSR in polarimetric configurations. In some embodiments of the invention, MFSR may be performed on already-enhanced images. Nevertheless, in various cases, MFSR may involve the first image enhancing techniques performed on “raw” (e.g., non-enhanced) frames. In several such embodiments, an “on” frame may be set as a “key” frame. Systems in accordance with many embodiments of the invention may separately build “on” and “off” raw image priors (and use interpolated data to match the “off” frame to the guide frame, in the case where the “off” frame may be viewed as very dark and noisy). This opens the possibility of subtraction being performed post-MFSR and/or post-MFNR.

The decision to perform image enhancement in this manner can depend on the exact pixel layout. Systems in accordance with certain embodiments of the invention may perform MFSR on raw frames by:
(1) Grouping the pixels into subsampled images according to specific polarizations in the raw image, and considering them separately (i.e., a subsampled image of H-target pixels, a subsampled image of V-target pixels, etc.);
(2) Generating a “guide” frame using some combination of the subsampled images, and tracking how the frame evolves temporally (across frames) by some algorithm (e.g., optical flow);
(3) Registering subsequent temporal frames according to the guide frame; and
(4) Interpolating each subsampled raw image, using the guide frame to influence the interpolation onto the final image.

Process 100 applies (140) the synthesized images to identification purposes. This synthesis may, for example, take the form of RGB images (e.g., in contrast to the initial NIR images). In applying (140) the synthesized images, process 100 may perform various identification and/or authentication operations, including but not limited to polarimetric imaging, anti-spoof detection, face recognition, iris recognition, palm recognition, fingerprint recognition, retinal scan, eye tracking, facial identification and matching, and/or allowing access to other programs/devices based on the results of these various operations. For example, the synthesized images may be used in a facial recognition program in a device (e.g., a cell phone, a computer) to confirm a spoof image is not being used (and/or that a real human can be identified) via facial analysis applied extract underlying features from targets including (but not limited to) the synthesized images themselves and/or 3D face masks derived from the synthesized images. In many embodiments of the invention, these features may be used in (image) classifiers and/or recognition programs (e.g., to identify when presented subjects are live people or a synthetic objects). Additionally or alternatively, the facial recognition program may be used to identify when the face of a human is a match for the previously entered face image of that specific human. Examples of methods for utilizing polarization states for biometric identification are described in U.S. Pat. Pub. No. 2023/0196842, entitled “Spoof-Resistant Facial Recognition Through Illumination and Imaging Engineering” and filed Dec. 16, 2022, which is hereby incorporated by reference in its entirety for all purposes.

While specific processes for image processing are described above, any of a variety of processes can be utilized for identification as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to multi-frame implementations, the techniques disclosed herein may be used in any type of imaging processes.

Multi-frame (MF) techniques implemented in accordance with many embodiments of the invention may involve gathering temporal and/or spatial aspects of image signals. In doing so, the MF techniques are robust to ambient noise/signals and may use on and off illumination to reduce stray light and/or other non-illuminator-sourced light (e.g., allowing the techniques to subtract these ambient signals from the signals). In some embodiments, MF techniques may implement subtraction techniques including but not limited to background subtraction techniques. In many embodiments of the invention, subtraction techniques may be performed across the sensor(s) regardless of individual pixel sensing. These subtraction techniques may enable systems operating in accordance with several embodiments of the invention to extract (refined) images. Extracting images that can be used by machine learning models (configured in accordance with various embodiments of the invention) may utilize various discriminating techniques. In accordance with certain embodiments of the invention, singular image sensors stacked with metasurfaces can generate multiple information channels (e.g., S0, S1, S2 Stokes vector images). In doing so, systems may implement any algorithms which convert raw pixel readouts to (S0, S1, S2) YUV formats. Further, downstream machine learning models can use these information channels to extract discriminating signals for various uses (e.g., biometrics, air quality, skin hydration).

As mentioned above, in accordance with numerous embodiments of the invention, enhancement may be performed across multiple images, such as when reducing noise. In doing so, intricacies with using multi-image noise reduction may be different than those encountered during picture enhancement and noise reduction in camera images for human viewing. For example, unique aspects of utilizing multiple images in biometric authentication processes may be evident using (e.g., NIR, polarized) images.

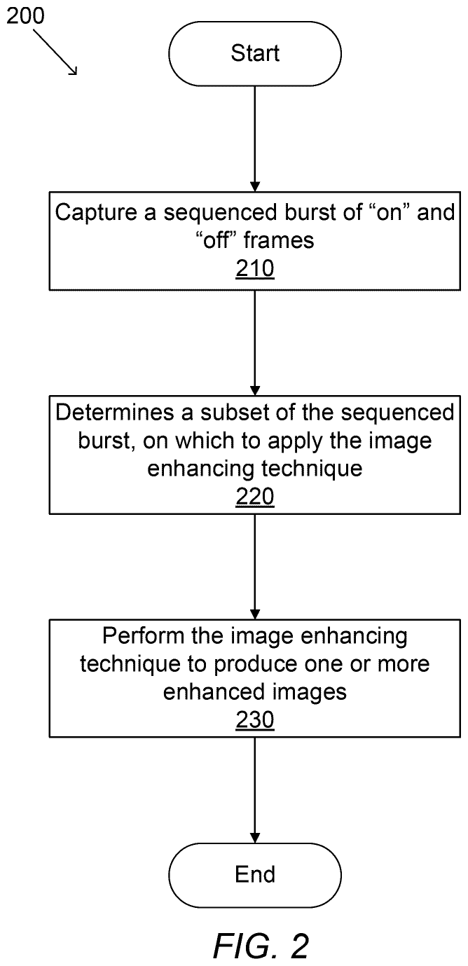

An example of a multi-image noise reduction process implemented in accordance with numerous embodiments of the invention is illustrated in FIG. 2. Process 200 captures (210) a sequenced burst of “on” and “off” frames. In accordance with various embodiments, these frames may be obtained using singular image sensors (i.e., via alternating configurations) and/or groups of image sensors. In many embodiments, process 200 may collect the same number of “on” frames and “off” frames. In some cases, “on” and “off” frames may be captured alternately (i.e., when an “on” frame is captured followed by an “off” frame). In several embodiments, bursts of alternating frames may be captured (i.e., a burst of “on” frames may be captured and then a burst of “off frames”), where the bursts are multiple frames captured in succession. Process 200 determines (220) a subset of the sequenced burst, on which to apply the image enhancing technique. For example, image enhancing techniques may be utilized on the “on” frames only; on the “on” frames and “off” frames together; or on the “off frames” only. Process 200 performs (230) the image enhancing technique to produce one or more enhanced images. As mentioned above, potential image enhancing techniques may include but are not limited to MFNR techniques in accordance with many embodiments of the invention.

Image enhancement processes may significantly improve the efficiency of any identification processes used on the resulting (synthesized) images. For example, in one scenario, the captured frames may depict a face using image sensors at a significant distance. In such cases, the number of pixels in the object may be too low for identification (e.g., authentication) processes to be effective. In doing so, the captured “off” frames may be considered representations of the ambient environment around the object. As such, they can be subtracted, omitted, or otherwise removed from the “on” frames to optimize the signal(s) around the object. In some embodiments, to capture “off” frames, ambient light sources may be utilized since the ambient light would be used to capture the frames. However, other approaches may be implemented for images obtained in areas without ambient light, such as dark rooms or at night outside.

While specific processes for multi-frame super-resolution and noise reduction techniques are described above, any of a variety of processes can be utilized for identification as appropriate to the requirements of specific applications. In some embodiments, steps may be executed or performed in any order or sequence not limited to the order and sequence shown and described. In various embodiments, some of the above steps may be executed or performed substantially simultaneously where appropriate or in parallel to reduce latency and processing times. In several embodiments, one or more of the above steps may be omitted. Although the above embodiments of the invention are primarily described in reference to MFNR implementations, the techniques disclosed herein may be used in any type of enhancement processes.

In some embodiments of the invention, degrees of enhancement may vary. For example, in one image enhancement process, Image 1 (“off”) and Image 2 (“on”) may be captured. For each pixel, an operator may be performed in order to produce an Enhanced Image. For instance, the operator may involve averaging such that at least some of the pixels of Image 1 and Image 2 are averaged, thereby removing the corresponding noise. In another example, the operator may be a subtraction process in which at least some of the pixels from Image 1 are (e.g., partially) subtracted from Image 2. In another example, the operator may utilize multiple pixels to manipulate a single pixel. Here, the operator may utilize clusters of adjacent pixels in each of Image 1 and/or Image 2 to adjust a single pixel of the corresponding Enhanced Image. In many embodiments, processing may occur on a given pixel on Image 1, in relation to the same pixel location on Image 2-i.e., pixel (A, B) on Image 1 used to modify pixel (A, B) on Image 2. While this example utilizes only two images, Image 1 and Image 2, any number of input images may be used for such processes in accordance with multiple embodiments of the invention.

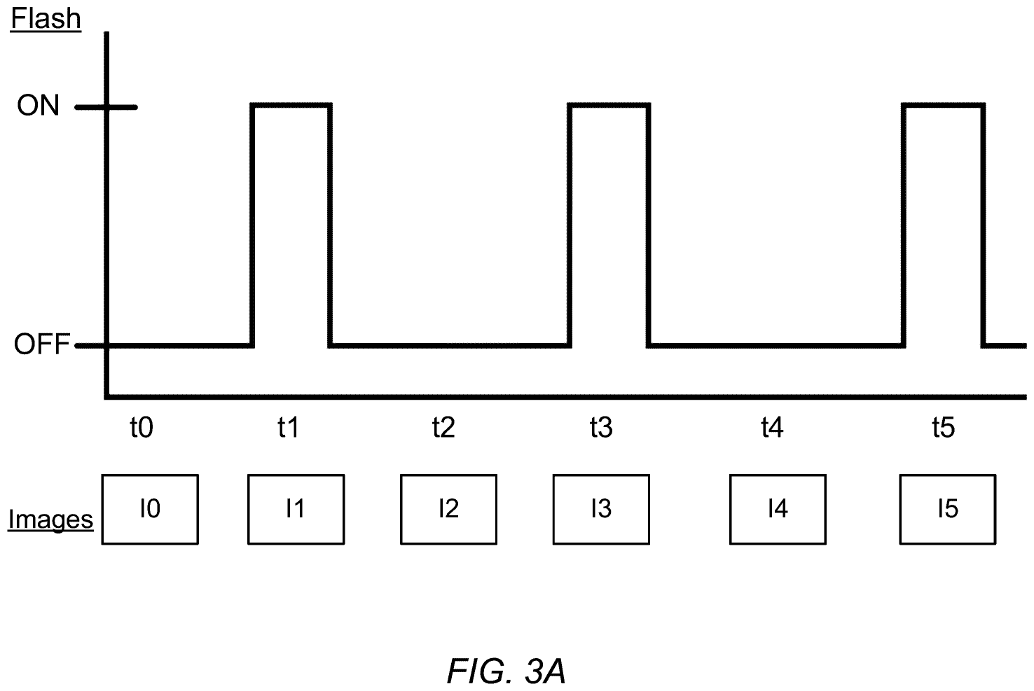

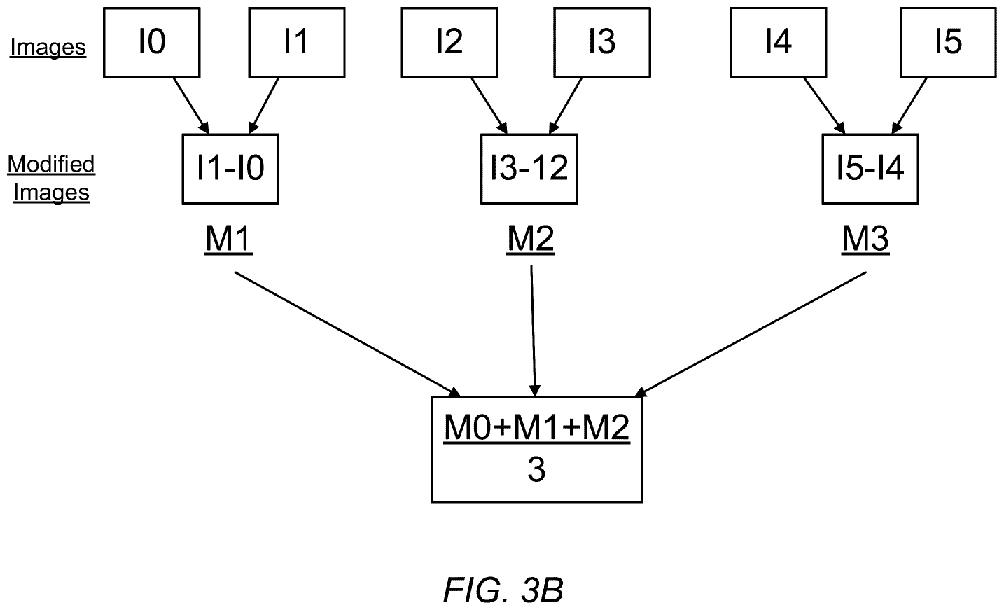

A schematic timing diagram of an example multi-frame enhancement process, performed in accordance with several embodiments of the invention, is illustrated in FIGS. 3A-3B. Images (I₀, I₁, I₂, I₃, I₄, I₅) are taken with alternating illumination configurations. Specifically, image set (I₀, I₂, I₄) is taken with the flash (i.e., illumination) off and image set (I₀, I₂, I₄) is taken with the flash on. The adjacent “illumination on” and “illumination off” pairings are subtracted to create modified images (M₁=I₁−I₀, M₂=I₃−I₂, M₃=I₅−I₄), representing a process where the “illumination off” frame is detracted from the “illumination on” frame to remove stray/non-illuminator light. An additional step is incorporated in FIG. 3B, wherein the modified images are averaged, an operation intended for reducing noise. In accordance with numerous embodiments of the invention, modifications may be performed pixel-by-pixel such that pixels of different frames (near or at the same location in each), are modified. Further, as mentioned above, operations besides subtraction and/or averaging may be used to enhance images in accordance with various embodiments of the invention. For example, instead of averaging the modified images, the pixels of the modified images may be used to interpolate pixels. Specifically, super resolution images may be created by merging (origin) pixels from the input images.

As mentioned above, multiple frames are accumulated in order to preserve precision. That said, when images are interpreted from sensors (e.g., in YUV format), they may be presented as 10-bit images (P010 image format). This may, specifically, be effective when the sensor has a native resolution that is at least 10-bit. Image enhancement may operate on the respective luma and chroma channels, with the channels aiding in denoising. During many image enhancements, the values may be accumulated to the final output image by summing. Because the image format is 10-bit, buffers may allow accumulation into the final output image without truncating bits, preserving precision which would otherwise be lost in an operation like averaging. As a last step, the image may be shifted into the appropriate 10-bit size and then output as a 10-bit enhanced image (and/or down-shifted to an 8-bit YUV output, when required).

Additionally or alternatively, in some embodiments of the invention, the accumulation may be performed on raw inputs. For example, certain images may be (produced on and) received from the image sensors in a raw format (8-bit, 10-bit, etc.). When the images are polarized, according to the pixel design, different intensities may be measured by each pixel, proportional to incident polarization states.

The burst enhancement algorithm may identify and accumulate individual (Bayer-like) channels of the received images to generate enhanced sets of the individual channels. As above, the enhancement algorithm can accumulate the raw inputs into wider datatypes to preserve precision. In such cases, processes operating in accordance with various embodiments may only truncate the output to the required data width at the end. Additionally or alternatively, algorithms can preserve the wider, accumulated data, preserving the precision of the measurement. In either case, the data may be passed to the imaging pipeline's demosaicing (or de-bayering) algorithm(s), where it is processed and provided to downstream computer vision tasks. Methods and/or tasks in accordance with many embodiments of the invention, may be performed locally and/or on-device via the image processing pipeline disclosed above. Additionally or alternatively, certain processes may be performed (as part of) greater imaging systems.

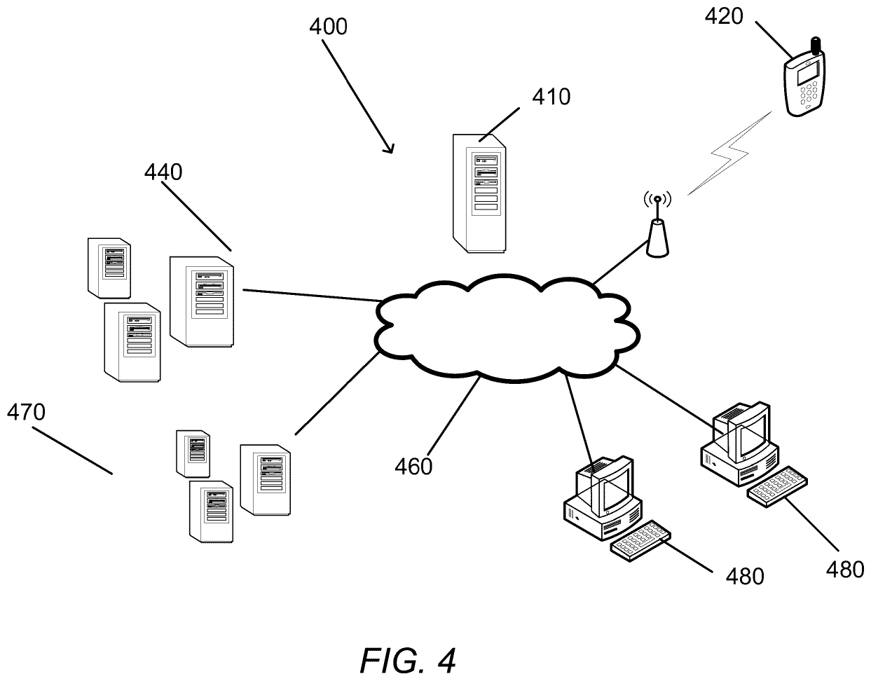

An example of an imaging system that performs image processing and computer vision tasks in accordance with various embodiments of the invention is illustrated in FIG. 4. Network 400 includes a communications network 460. The communications network 460 is a network such as the Internet that allows devices connected to the network 460 to communicate with other connected devices. Server systems 410, 440, and 470 are connected to the network 460. Each of the server systems 410, 440, and 470 is a group of one or more servers communicatively connected to one another via internal networks that execute processes that provide cloud services to users over the network 460. One skilled in the art will recognize that imaging systems may exclude certain components and/or include other components that are omitted for brevity without departing from this invention.

For purposes of this discussion, cloud services are one or more applications that are executed by one or more server systems to provide data and/or executable applications to devices over a network. The server systems 410, 440, and 470 are shown each having three servers in the internal network. However, the server systems 410, 440, and 470 may include any number of servers and any additional number of server systems may be connected to the network 460 to provide cloud services. In accordance with various embodiments of this invention, imaging systems that provide image data in accordance with an embodiment of the invention may be provided by a process being executed on a single server system and/or a group of server systems communicating over the network 460.

Users may use individual computing devices 480 and 420 that connect to the network 460 to perform processes for authentication in accordance with various embodiments of the invention. In the shown embodiment, the computing devices 480 are shown as desktop computers that are connected via a conventional “wired” connection to the network 460. However, the personal device 480 may be a desktop computer, a laptop computer, or any other device that connects to the network 460 via a “wired” connection. The mobile device 420 connects to network 460 using a wireless connection. A wireless connection is a connection that uses Radio Frequency (RF) signals, Infrared signals, or any other form of wireless signaling to connect to the network 460. In the example of this figure, the mobile device 420 is a mobile telephone. However, mobile device 420 may be a mobile phone, a Personal Digital Assistant (PDA), a tablet, a smartphone, or any other type of device that connects to network 460 via wireless connection without departing from this invention.

As can readily be appreciated, the specific computing system used imaging is largely dependent upon the requirements of a given application and should not be considered as limited to any specific system implementation.

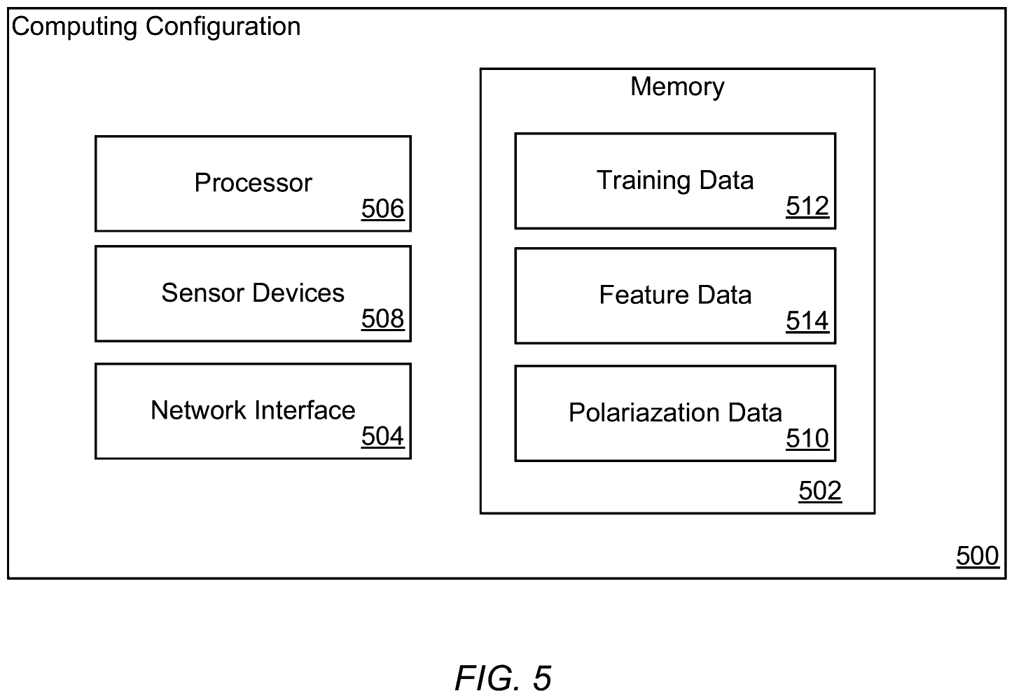

A block diagram of a computing configuration which may be used for authentication and/or identification purposes (e.g., facial recognition) in accordance with many embodiments of the invention is illustrated in FIG. 5. The computing configuration 500 may be distributed in the form of separate computing devices/systems and/or be directly incorporated into the system(s) capturing the images, such as a smartphone. The computing configurations 500 may include but are not limited to a network interface 504 which is capable of receiving 2D images including polarized and/or NIR images; a processor 506; a memory 502; and sensor devices 508.

The processor 506 can include (but is not limited to) a processor, microprocessor, controller, or a combination of processors, microprocessor, and/or controllers that perform instructions stored in the memory 502 to manipulate data stored in the memory 502. Processor instructions can configure the processor 506 to perform processes in accordance with certain embodiments of the invention. In various embodiments, processor instructions can be stored on a non-transitory computer-readable and/or machine-readable medium.

The memory 502 may store data including, but not limited to image data, training data 512, feature data 514, and polarization data 510. The training data 512 may be used in training the (e.g., machine learning) models used in performing processes in accordance with various embodiments of the invention. The feature data 514 may be used for comparing the initial image(s) with the later captured image(s) as discussed above. Additionally or alternatively, features represented through the feature data 514 may be used to modify and/or enhance images as described above. The polarization data 510 may include determinations of the polarization of captured images for purposes including but not limited to polarimetry.

Sensor devices 508 can include any of a variety of components for capturing data, such as (but not limited to) cameras and/or image sensors. In a variety of embodiments, Sensor devices 508 can be used to gather inputs and/or provide outputs, including but not limited to image data. Further, image sensors and/or cameras implemented in accordance with certain embodiments of the invention may vary in configuration. In certain embodiments, imaging systems may include both an active illumination source and an imaging sensor or camera. The illumination source may be an illumination device, and the imaging sensor or camera may be a sensor device.

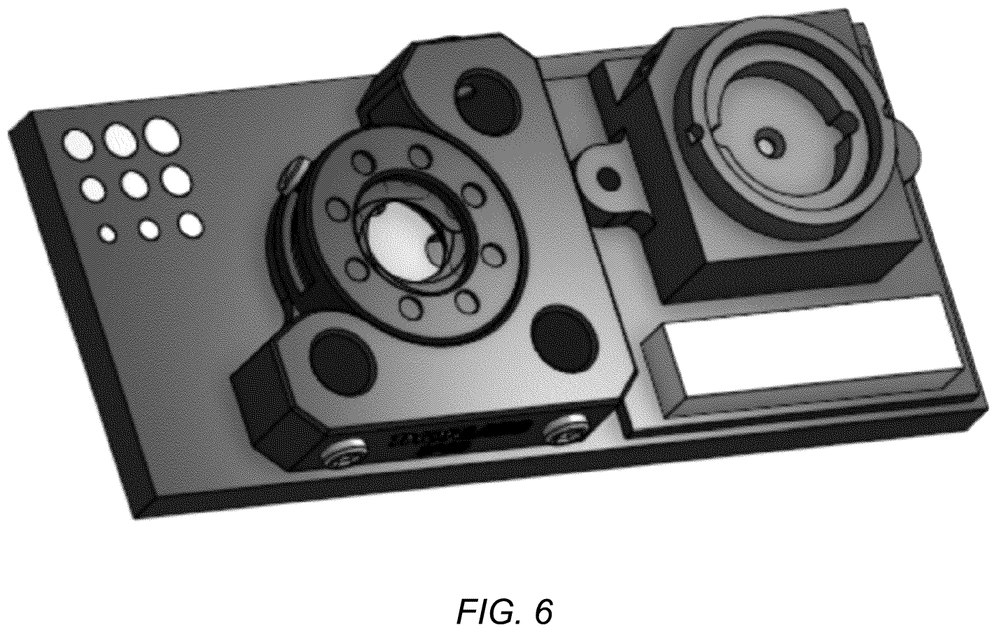

A combined imaging module in accordance with some embodiments of the invention is illustrated in FIG. 6. The module includes an active illumination/light source and a camera which can resolve polarization. While the imaging module of FIG. 6 includes an active illumination source, the illumination source used in accordance with some embodiments may also be sunlight, ambient light, and/or sunlight/ambient light supplemented with a light source such as a light-emitting diode (LED) and/or vertical-cavity surface-emitting laser (VCSEL) array. The sunlight or ambient light may have a random polarization state in it and also includes a range of wavelengths (e.g., NIR wavelengths). In several embodiments, an ambient light sensor may be utilized to turn on or off the light source, or alter the intensity or pattern of the light source, depending on the sunlight/ambient conditions (e.g., the amount of sunlight present). For example, some modules may just use sunlight in certain conditions and/or use both the light source and sunlight in some conditions. Numerous modules may alter the amount of light from the light source dependent on the sunlight conditions. A bandpass filter may be included to filter the wavelengths of the sunlight to only pass one wavelength and/or a narrow band of wavelengths.

In many cases, the light source may be unpolarized, have variable polarization, or have a fixed polarization state. For example, the light source may be a VCSEL array with a fixed VCSEL polarization. The fixed VCSEL polarization may be achieved through a patterned metasurface aperture on the VCSEL array to achieve a uniform polarization state out of the VCSEL array. In some embodiments, a light source with a fixed polarization state may provide better results than a light source without a polarization. The fixed polarization state may be a linear polarization of light, a circularly polarized light, and/or an elliptically polarized light or any combination of these polarizations of light.

Additionally or alternatively, the illumination source(s) can be preferentially-polarized or unpolarized. In some embodiments, the illumination sources may switch between two or more polarizations in a time resolved method or where it puts out multiple different polarizations in the field of interest. For example, either alternating polarization states may be presented at different times, or two polar states may be presented at the same time. The two polarization states may be orthogonal to each other, or non-orthogonal, and they may be two or more of the group including linear, circular, and elliptical states. The polarizations may be presented with different patterns of the polarization states, such as for example, flood, dot pattern, batwing pattern, top hat pattern, super-gaussian pattern or other illumination patterns.

In certain embodiments, the camera (and/or the illumination source) includes one or more metasurfaces configured to produce one or more polarization images with different polarization states. Further, the metasurface(s) may be used to produce the various polarization illumination patterns, in ways simultaneously or alternating; overlapping or physically separated; and/or with different patterns. Examples of illumination sources and cameras including metasurfaces are described in U.S. Pat. Pub. No. 2019/0064532, entitled “TRANSMISSIVE METASURFACE LENS INTEGRATION” and filed Aug. 31, 2018, which is hereby incorporated by reference in its entirety for all purposes.

Imaging systems corresponding to some embodiments may correspond to any imaging system capable of recovering the full polarization information. In such systems, polarimetry on input images may be performed by division-of-focal plane approaches, as implemented by integrated metasurface optical elements. Nevertheless, methods implemented in accordance with many embodiments of the invention are applicable to polarimetry on, but are not limited to, any division-of-focal plane systems, including those with integrated polarizers on image sensor pixels.

However, in a more specific case, the imaging system may include one or more metasurface optical elements, standard refractive lenses, and a standard CMOS image sensor. The one or more metasurface optical elements may split the scene into two or more polarization states and form two or more sub-images on the CMOS sensor and when these images are suitably computationally recombined, can provide the polarization state of the object being imaged. One example of these metasurface configurations is polarization splitting metasurfaces. Polarization splitting metasurfaces, or sparse metasurfaces, are described in U.S. Pat. Pub. No. 2023/0314827, entitled “Polarization Sorting Metasurface Microlens Array Device” and filed Mar. 31, 2023, which is hereby incorporated by reference in its entirety for all purposes.

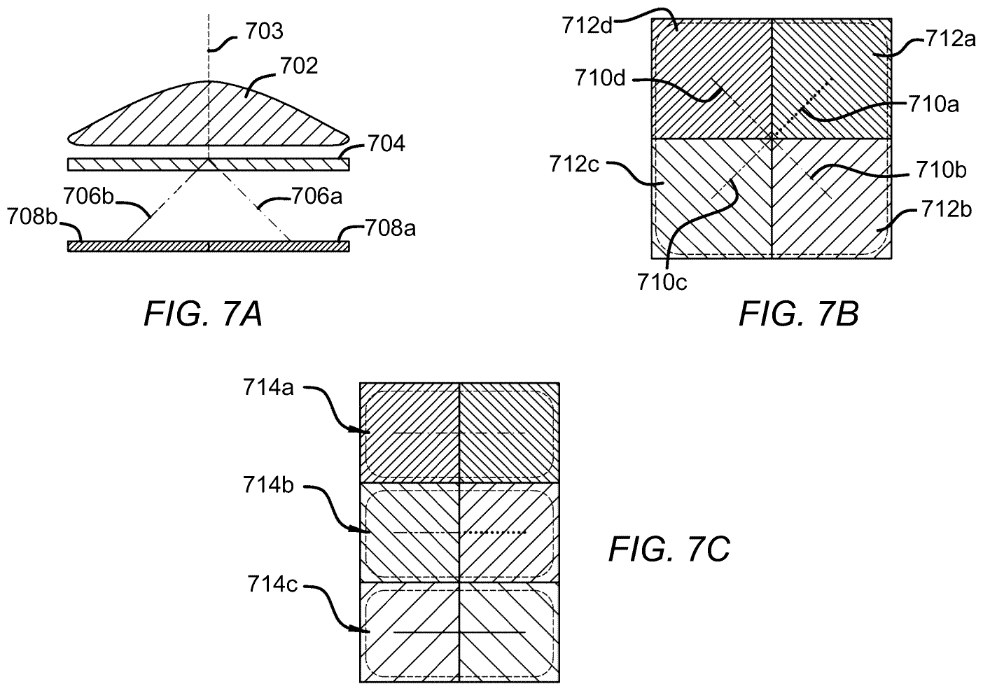

A set of views of an image sensor configured in accordance with miscellaneous embodiments of the invention is illustrated in FIGS. 7A-7C. FIG. 7A is a cross-sectional view of the image sensor, configured to include (but not limited to) polarization splitting capability. The imaging device includes a microlens 702 which directs light 703 into a polarization splitting metasurface 704. The microlens 702 may be part of a microlens array. The polarization splitting metasurface 704 splits the light 703 into a first polarization light 706a and a second polarization light 706b. The first polarization light 706a and the second polarization light 706b may have orthogonal polarizations. An image sensor including a first region 708a and a second region 708b is positioned below the polarization splitting metasurface 704. The first polarization light 706a is directed into the first region 708a and the second polarization light 706b is directed into the second region 708b. The microlens 702 is offset from the first region 708a and the second region 708b such that the center of the microlens 702 is between the first region 708a and the second region 708b.

Each microlens 702 may cover at least half of the first region 708a and the second region 708b with the overlapping metasurface lenslet 704 between used to diffract the first polarization light 706a into the first direction into the first region and the second polarization light 706b into the second direction into the second region. The first polarization light 706a may be an orthogonal polarization to the second polarization light 706b.

FIG. 7B is a plan view of an imaging device in accordance with an embodiment of the invention. The imaging device includes the microlens and the polarization splitting metasurface described above. The polarization splitting metasurface splits light into a first polarization light 710a, a second polarization light 710b, a third polarization light 710c, and a fourth polarization light 710d. The imaging device includes an image sensor including a first region 712a, a second region 712b, a third region 712c, and a fourth region 712d. The first polarization light 710a is directed into the first region 712a, the second polarization light 710b is directed into the second region 712b, the third polarization light 710c is directed into the third region 712c, and the fourth polarization light 710d is directed into the fourth region 712d.

FIG. 7C is a plan view of an imaging device including polarization splitting capability in accordance with an embodiment of the invention. The imaging device includes a first polarization splitting portion 714a, a second polarization splitting portion 714b, and a third polarization splitting portion 714c which are each structured similarly to the imaging device described in connection with FIG. 7A. As illustrated, in each of the first polarization splitting portion 714a, the second polarization splitting portion 714b, and the third polarization splitting portion 714c, split light such that different polarizations are split into different directions. Each of the first polarization splitting portion 714a, the second polarization splitting portion 714b, and the third polarization splitting portion 714c may operate on different polarizations. For example, the first polarization splitting portion 714a may split light into a first polarization and a second polarization whereas the second polarization splitting portion 714b into a third polarization and a fourth polarization.

Systems and techniques directed towards biometric imaging, in accordance with certain embodiments of the invention, are not limited to use within polarization cameras. Accordingly, it should be appreciated that applications described herein can be implemented outside the context of a polarization camera. Moreover, any of the systems and methods described herein with reference to FIGS. 1-7C can be utilized within any of the configurations described above.

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method of performing biometric identification, the method comprising:
capturing an “off” set of frames and an “on” set of frames, wherein:
the “off” set of frames depicts an object when illuminated by externally-sourced illumination;
the “on” set of frames depicts the object when illuminated by the externally-sourced illumination and an illuminator; and
the “off” set of frames and the “on” set of frames are each polarized in a set of near-infrared wavelengths; and
performing at least one image enhancing technique to produce a denoised image, wherein the at least one image enhancing technique:
comprises a multi-frame noise reduction technique based on a plurality of spatial aspects of image signals in both of:
the “off” set of frames; and
the “on” set of frames; and
removes the externally-sourced illumination from the “on” set of frames in producing the denoised image; and
performing an authentication based on the denoised image.

2. The method of claim 1, wherein performing the at least one image enhancing technique comprises inputting the “off” set of frames and the “on” set of frames into a trained machine learning algorithm.

3. The method of claim 1, wherein the at least one image enhancing technique comprises performing a polarimetric measurement of at least one of the “off” set of frames or the “on” set of frames.

4. The method of claims 1, wherein:
the object is a human face; and
the authentication comprises at least one selected from the group consisting of an anti-spoof detection, a face recognition, an iris recognition, a palm recognition, a fingerprint recognition, a retinal scan, an eye tracking, a facial matching, and an access determination.

5. The method of claim 1, wherein the at least one image enhancing technique further comprises a multi-frame super resolution technique based on the plurality of spatial aspects of the image signals.

6. The method of claim 1, wherein:
each individual frame obtained for the “on” set of frames alternates with a counterpart frame obtained for the “off” set of frames; and
performing the multi-frame noise reduction technique comprises, for the each individual frame, subtracting the counterpart frame from the each individual frame to create an individual modified frame.

7. The method of claim 6, wherein subtracting the counterpart frame from the each individual frame comprises subtracting pixels at a consistent location in both frames.

8. The method of claim 6, wherein performing the multi-frame noise reduction technique further comprises averaging a set of individual modified frames to reduce noise in the denoised image.

9. The method of claim 8, wherein averaging the set of individual modified frames comprises averaging pixels across a consistent location in each individual modified frame.

10. The method of claim 1, wherein:
the “off” set of frames and the “on” set of frames are both captured in YUV format; and
the at least one image enhancing technique operates on luma (Y) and chroma (U, V) channels.

11. A non-transitory machine-readable medium comprising instructions that, when executed, are configured to cause a processor to perform a biometric identification process, the biometric identification process comprising:
capturing an “off” set of frames and an “on” set of frames, wherein:
the “off” set of frames depicts an object when illuminated by externally-sourced illumination;
the “on” set of frames depicts the object when illuminated by the externally-sourced illumination and an illuminator; and
the “off” set of frames and the “on” set of frames are each polarized in a set of near-infrared wavelengths; and
performing at least one image enhancing technique to produce a denoised image, wherein the at least one image enhancing technique:
comprises a multi-frame noise reduction technique based on a plurality of spatial aspects of image signals in both of:
the “off” set of frames; and
the “on” set of frames; and
removes the externally-sourced illumination from the “on” set of frames in producing the denoised image; and
performing an authentication based on the denoised image.

12. The non-transitory machine-readable medium of claim 11, wherein performing the at least one image enhancing technique comprises inputting the “off” set of frames and the “on” set of frames into a trained machine learning algorithm.

13. The non-transitory machine-readable medium of claim 11, wherein the at least one image enhancing technique comprises performing a polarimetric measurement of at least one of the “off” set of frames or the “on” set of frames.

14. The non-transitory machine-readable medium of claim 11, wherein:
the object is a human face; and
the authentication comprises at least one selected from the group consisting of an anti-spoof detection, a face recognition, an iris recognition, a palm recognition, a fingerprint recognition, a retinal scan, an eye tracking, a facial matching, and an access determination.

15. The non-transitory machine-readable medium of claim 11, wherein the at least one image enhancing technique further comprises a multi-frame super resolution technique based on the plurality of spatial aspects of the image signals.

16. The non-transitory machine-readable medium of claim 11, wherein:
each individual frame obtained for the “on” set of frames alternates with a counterpart frame obtained for the “off” set of frames; and
performing the multi-frame noise reduction technique comprises, for the each individual frame, subtracting the counterpart frame from the each individual frame to create an individual modified frame.

17. The non-transitory machine-readable medium of claim 16, wherein subtracting the counterpart frame from the each individual frame comprises subtracting pixels at a consistent location in both frames.

18. The non-transitory machine-readable medium of claim 16, wherein:
performing the multi-frame noise reduction technique further comprises averaging a set of individual modified frames to reduce noise in the denoised image; and
averaging the set of individual modified frames comprises averaging pixels across a consistent location in each individual modified frame.

19. The non-transitory machine-readable medium of claim 11, wherein:
the “off” set of frames and the “on” set of frames are both captured in YUV format; and
the at least one image enhancing technique operates on luma (Y) and chroma (U, V) channels.

20. An imaging device for performing a biometric identification, the imaging device comprising:
a camera comprising:
an illuminator; and
at least one polarization image sensor;
a memory, storing instructions; and
a processor configured to communicate data with the camera and the memory, the processor further configured to execute the instructions to:
capture, using the at least one polarization image sensor, an “off” set of frames and an “on” set of frames, wherein:
the “off” set of frames depicts an object when illuminated by externally-sourced illumination;
the “on” set of frames depicts the object when illuminated by the externally-sourced illumination and the illuminator; and
the “off” set of frames and the “on” set of frames are each polarized in a set of near-infrared wavelengths; and
perform at least one image enhancing technique to produce a denoised image, wherein the at least one image enhancing technique:
comprises a multi-frame noise reduction technique based on a plurality of spatial aspects of image signals in both of:
the “off” set of frames; and
the “on” set of frames; and
removes the externally-sourced illumination from the “on” set of frames in producing the denoised image; and
perform an authentication based on the denoised image.
